(19) United States
(12) Patent Application Publication
(10) Pub. No.: US 2012/0089581 A1
(43) Pub. Date: Apr. 12, 2012

(54) Informing Search Results Based on Commercial Transaction Publications

(75) Inventors: Anoop Gupta, Redmond, WA (US); Thore Graepel, Cambridge (GB); Ralf Herbrich, Cambridge (GB)

(73) Assignee: Microsoft Corporation, Redmond, WA (US)

(21) Appl. No.: 12/899,569

(22) Filed: Oct. 7, 2010

(51) Int. Cl. G06F 17/30; G06F 15/16

(52) U.S. Cl. 707/706; 709/204; 707/E17.108; 707/E17.032

(57) ABSTRACT

A publishing engine captures capturing commercial events and other information (collectively, “commercial information”) associated with a first user and automatically notifies other users in the social network of the first user of this commercial information. The publishing engine also notifies one or more search engines of these events and information. Based on this commercial information, the search engine can augment search results of the members of the social network to include historical notifications relating to commercial transactions for similar products and/or services by others in their social network. In this manner, for example, the search engine can provide results directing the searcher to other users in their social network who have purchased such products and/or services.

### CROSS-REFERENCE TO RELATED APPLICATIONS

The present application is related to U.S. patent application Ser. No. 12/818,170, entitled “Reconstructing the Flow of Online Recommendations” and filed on Jun. 18, 2010, and Ser. No. 12/818,161, entitled “Pricing in Social Advertising” and filed on Jun. 18, 2010, which are specifically incorporated by reference herein for all that they disclose and teach.

The present application is related to U.S. patent application Ser. No. ______ [MS330004.01], entitled “Publishing Commercial Information in a Social Network” and filed on, which is specifically incorporated by reference herein for all that it discloses and teaches.

### BACKGROUND

Personal recommendations and word-of-mouth advertising can greatly influence an individual's purchase decision. Generally, a consumer is more likely to purchase a product or service based on referral from someone they know and/or trust than based on a referral from someone they do not know or an advertisement from a self-interested party. With the arrival of online communication services, such as email, blogs, microblogging services, social networking services, and electronic commerce sites, personal recommendations and word-of-mouth advertising proliferate in an online fashion. Providing incentives to recommending users and to those users who consume recommendations (e.g., shop and/or purchase on the basis of such recommendations) can amplify the effect of such advertizing. However, fairly yet effectively incentivizing the participants in such advertising (e.g., recommending and recommended users) to encourage recommendations is a challenging problem.

Furthermore, even with incentives, users may tend to forgo the effort of sending deliberate recommendations for each product or service they find interesting. Accordingly, depending solely on deliberate recommendations originated by users (e.g., purchasers, shoppers, etc.) may result in many potential recommendations that are never communicated. Such a result fails to capture a lot of important information that may be helpful to others when making purchasing decisions.

### SUMMARY

Implementations described and claimed herein address the foregoing problems by capturing commercial events and other information (collectively, “commercial information”) associated with a first user and automatically notifying other users in the social network of the first user of this commercial information. The publishing engine also notifies one or more search engines of these events and information. Based on this commercial information, the search engine can augment search results of the members of the social network to include historical notifications relating to commercial transactions for similar products and/or services by others in their social network. In this manner, for example, the search engine can provide results directing the searcher to other users in their social network who have purchased such products and/or services.

Other implementations are also described and recited herein.

### BRIEF DESCRIPTION OF THE DRAWINGS

FIG. 1 illustrates an example e-commerce system including an e-commerce site for performing commercial transactions, a publication service for publishing notifications to a social network, and an incentive service for allocating incentives.

FIG. 2 illustrates an example e-commerce system for capturing and publishing commercial information in a social network and allocating incentives among multiple users.

FIG. 3 illustrates an example architecture of an e-commerce system capable of capturing and publishing commercial information to a social network and allocating incentives.

FIG. 4 illustrates example operations for authorizing publication of commercial information to a social network and collecting an incentive for doing so.

FIG. 5 illustrates example operations for publishing commercial information to a social network.

FIG. 6 illustrates an example search engine system including a search feature for commercial transaction publications within a social network.

FIG. 7 illustrates an example display of augmented search results.

FIG. 8 illustrates example operations for searching commercial transaction publications within a social network.

FIG. 9 illustrates an example system that may be useful in implementing the described technology.

### DETAILED DESCRIPTIONS

As an initial matter, a URI is an example of a resource identifier and represents a string of characters used to identify a resource on a network. A universal resource locator (URL) is an example type of URI that identifies both a network resource and a means of accessing the network resource. For example, the best-known example of a URL is the “address” of a web page on the World Wide Web, such as “http://www.microsoft.com”, wherein the URI scheme “http” implies that a representation of the identified network resource may be obtained via HTTP from a network host named “www.microsoft.com”. A universal resource name (URN) is another example type of URI.

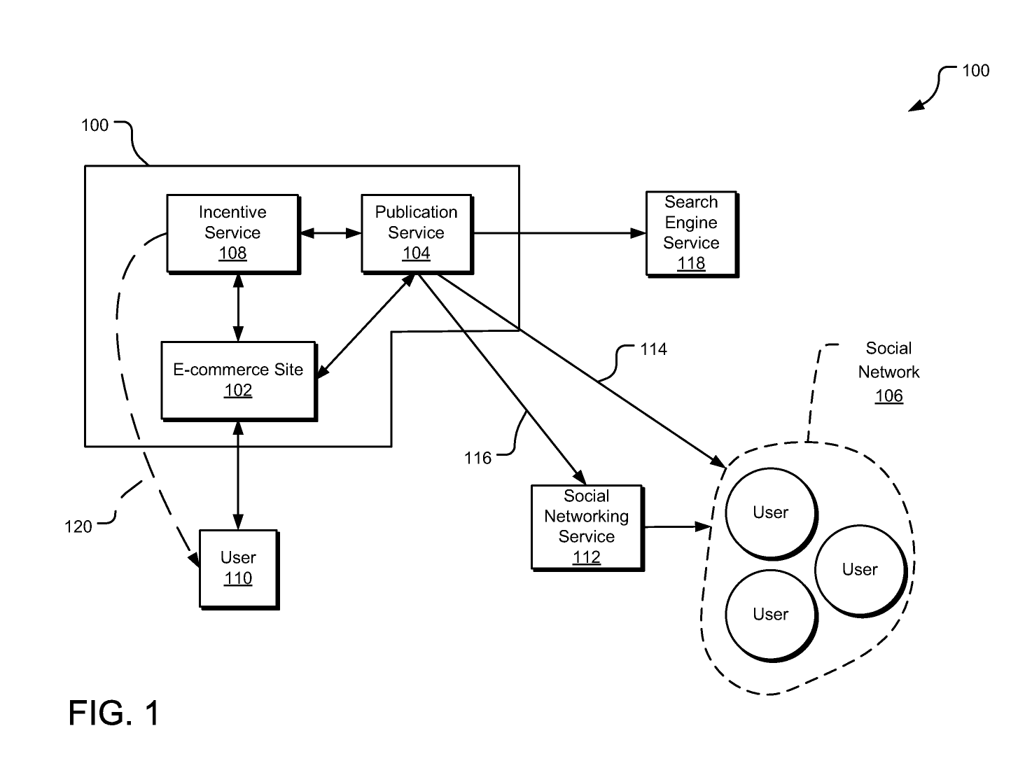

FIG. 1 illustrates an example e-commerce system 100 including an e-commerce site 102 for performing commercial transactions, a publishing service 104 for publishing notifications to a social network 106, and an incentive service 108 for allocating incentives. The term “commercial transaction” refers to an exchange of something of economic value, including without limitation a purchase (e.g., involving the exchange of money for a good or a service); a lease; a subscription, whether free or paid, to receive a newsletter (e.g., involving submission of contact information exchanged for periodic receipt of the newsletter); registration to a web account or other service (e.g., involving an exchange of registration information for the opportunity to access the web account or other service); etc. It should be understood that an obligation by one party to a commercial transaction may provide economic value to the other party. As such, an exchange of money is not a requirement of a commercial transaction. By publishing notifications of a user's purchases and other commercial transactions to other users in his or her social network 106, an e-commerce system 100 can drive additional traffic to the e-commerce site 102 and otherwise publicize its online presence and the products/services it sells.

A social network of a user represents a group of communication partners who have voluntarily chosen to engage in communication with the user and are eligible to receive specified communications from the user. Such communications may be one-way or two-way and are commonly electronic in nature, although physical communication (e.g., by post) may be employed alternatively. Typically, such communications are transmitted concurrently to multiple recipients in the user's social network, although some social networks may involve sequential or staged transmission (e.g., sending sequential emails, postal letters, phone calls via multiple distribution lists). In addition, recipients may have the capability to easily forward such communications to other recipients in their own social networks, allowing the communications to propagate through multiple social networks.

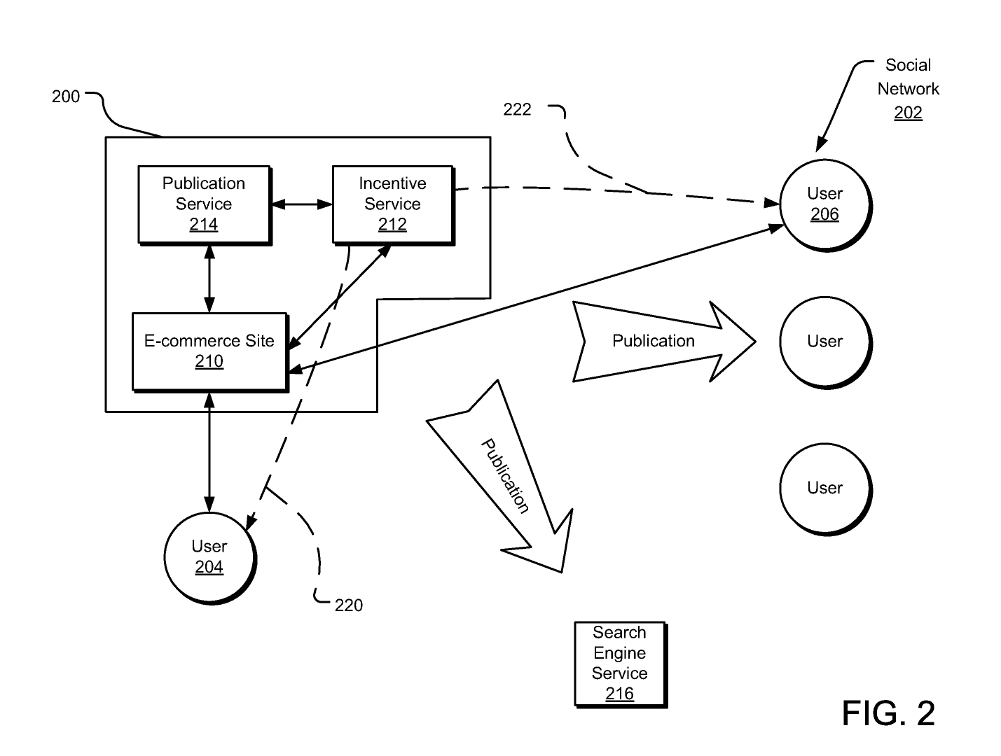

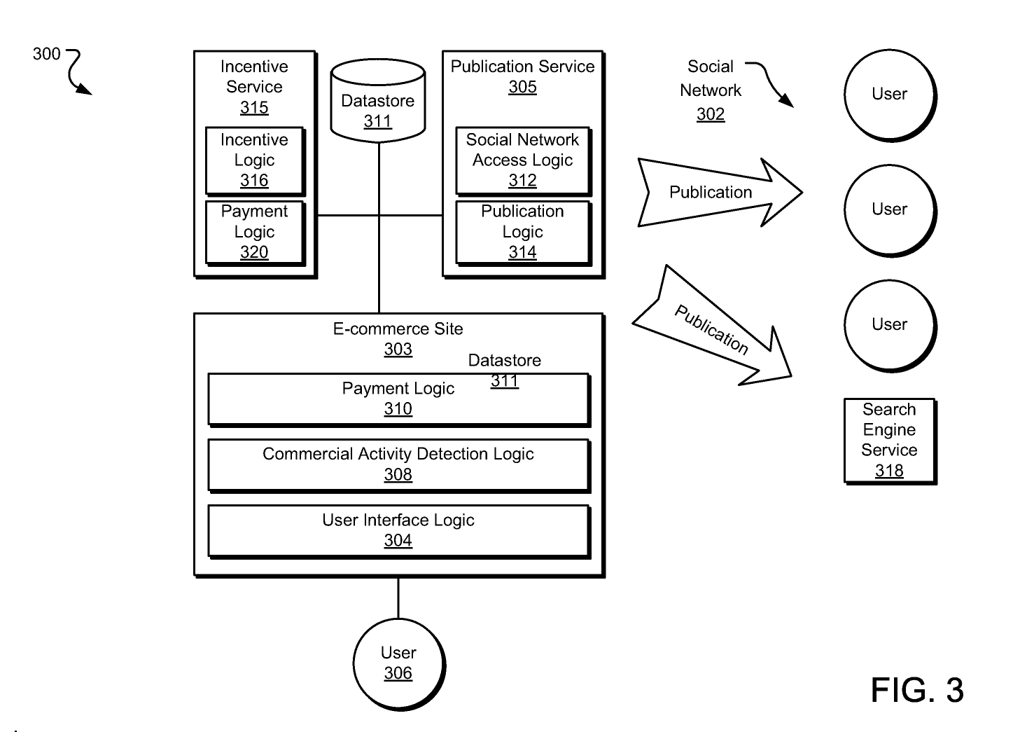

In the illustrated example, a user 110 visits the e-commerce site 102. Note: Users are designated in the figures by labeled blocks and are intended to represent the individual users and/or their computing systems. During some interaction with the e-commerce site 102, the user 110 is asked whether he or she would consent to publication of his or her commercial transactions to other users within the user's social network 106. In exchange for this consent, the e-commerce site 102 may offer certain incentives 120, including discounts on purchases, refunds, rebates, frequent flyer miles, additional storage space, etc., as computed by the incentive service 108 (which can be a component of an ad service). If the user 110 consents to such publication, the e-commerce system 100 collects social network information from the user 110, including without limitation credentials for accessing one or more of the user's social networking accounts. For example, the user 110 may consent to publication through his or her account on a social networking service 112, such as microblogging service like TWITTER or an online community service like FACEBOOK. Accordingly, the e-commerce system 100 (e.g., the publication service 102 within the e-commerce system 100) can collect the user's user ID and password for accessing the microblogging service or authenticating tokens for accessing the microblogging service. In some implementations, the publication service 104 may publish information about the user's commercial transaction through the social networking service 112 (see communication channel 116). In another implementation, if alternative contact information is available, the publication service 104 may publish information about the user's commercial transaction through a different channel 114 (e.g., email or postal service). In addition, as described in more detail with regard to FIGS. 2 and 3, the publication service 104 may publish information about the user's commercial transaction to a search engine 118.

Based on publication, the incentive service 108 determines an incentive 120 to attribute to the user 110. In one implementation, the user 110 can consent to publication and thereafter view an adjusted or discounted price for the product or service he or she is purchasing. In another implementation, the user 110 can consent to publication prior to the purchase session (e.g., during an account registration process in which the user sets up an account with the e-commerce system 100). In yet another implementation, the user 110 can consent to publication after executing a purchase, in which case the publication and incentives (e.g., credit for future purchases, other perks, etc.) can be retroactively applied.

As discussed with regard to FIG. 2, other incentives may be applied based on responses from the notified users in the social network 106. For example, if a notified user purchases a product or service in response to a publication, the incentive service 108 may allocate additional incentives to the new purchaser and/or the consenting user 110.

It should be understood that publication of commercial information and incentives to users can be accomplished offline as well. A brick-and-mortar retailer can capture purchases and other commercial research from shoppers via telephone or on site. With authorization by the shoppers and shopper-provided information about the shopper's friends (e.g., an identified social network of the shopper), including postal addresses, email addresses, telephone numbers, etc., the retailer, manufacturer, ad agencies, etc. can publish the commercial information captured from the shoppers to these friends. Incentives can be mailed, emailed, or otherwise provided to the shoppers and their friends in a similar manner as described with regard to the online publications and recommendations.

FIG. 2 illustrates an example e-commerce system 200 for capturing and publishing commercial information in a social network 202 and allocating incentives among multiple users, such as users 204 and 206. The user 204 executes a commercial transaction, such as a purchase, via the e-commerce site 210. By consenting to publication of his or her commercial transactions, the user 204 qualifies for certain incentives, such as discounts, rebates, etc., as determined by an incentive service 212. In response to such consent, the e-commerce site 210 may display a discounted price for the product or service of interest prior to completing the commercial transaction. Alternatively, the e-commerce site 210 may display another incentive, such as a number of reward points earned by publication, etc. (Note: If the user 204 withdrawals consent before the purchase or cancels publication of this particular commercial transaction, then the e-commerce site 210 may display the original, non-discounted price or omit/reduce the number of reward points.)

Responsive to a commercial transaction for which the user 204 has consented to publication, a publication service 214 publishes information about the commercial transaction to users in the social network 202 of the user 204 and/or to a search engine 216. The notification published by the publication service 214 may be an un-trackable or trackable notification. An example of an un-trackable notification may be a tweet or an email merely indicating that “Your friend just purchased a Brand X coffee maker from Retailer X!” without any information to allow the e-commerce system 200 to track back to the purchaser. In this scenario, the incentive service 212 may have allocated an incentive to the purchaser at purchase time (in compensation for publication), but the incentive service 212 does not have a means for discerning a relationship between the original purchaser and a member of his or her social network who responds to the publication by making a purchase.

It should be understood that some implementations may wish to keep the purchaser anonymous. Such implementations may use un-trackable notifications for this purpose. However, if the purchaser's social network is very small, any publication of a purchaser's activity may cause the purchaser to be easily identifiable (e.g., if the purchaser has only one member in his or her social network). As such, the e-commerce system 200 may simply refrain from publication if the publication is likely to identify a purchaser who is intended to remain anonymous (e.g., by not publishing if the size of the purchaser's social network is smaller than a threshold size).

In contrast, a trackable notification includes information that allows the incentive service 212 to link the original purchaser (i.e., the user 204) to a purchase made by a member of his or her social network 202, such as the user 206. An example trackable notification may include an identifier embedded in the notification to allow the incentive service 212 to track the purchases. For example, a trackable notification may be in the form “@JohnSmith just purchased a Brand X coffee maker from Retailer X! Check it out at http://mapped.URL/c6dMid,” wherein the string “http://mapped.URL/c6dMid” represents a URI that is mapped within the e-commerce system 200 to a URL of the e-commerce site 210 and to a user ID of the user 204 (and potentially a user ID of the user 206). In this manner, the incentive service 212 can link a purchase made by the user 206 through the trackable notification with the user 204 and therefore allocate incentives to either or both of them for actively participating in the commercial information publication program.

In one implementation, trackable notifications are associated with one or more mappings between the notification (or a URI in the notification), the published commercial information, incentive parameters, one or more products or services, and/or user IDs of the user 204 and/or the user 206. Such mappings may be stored in the datastore 311 and accessed by the incentive service 212, the publication service 214, and the e-commerce site 210. When a trackable notification is published, it is encoded with a notification identifier, one or more user IDs, a time stamp, and/or a trackable URI, which can be decoded using the mappings. In this manner, the system components can determine a variety of information, such as the identity of the user whose commercial information was published, the identity of a responding user, the commercial information corresponding to the notification or the response, etc. For example, if a social network user responds to a published trackable notification by navigating in accordance with a trackable URI and purchases the associated product or service, the incentive service 212 can record a user ID of the responding user 206 in association with a mapping to the user ID of the original user 204 and allocate incentives to both of them as a result of the responding user's purchase.

In some implementations, the e-commerce system 200 may also receive from the user 204 a publication qualifier expressing an opinion, such as “like,” “dislike,” “refer,” etc. For example, if the user wishes to recommend that friends avoid buying a product reviewed at a particular URI, the user 204 can attribute a “dislike” publication qualifier to the publication authorization before sending it to the e-commerce system 200. Publication qualifiers may also be recorded by the e-commerce system 200 and used by the e-commerce site 210, the incentive service 212, the publication service 214, or other means to evaluate marketing trends, etc.

The user 206 is referred to as a “consuming user” because the user 206 receives a publication and acts on it. In some implementation, the e-commerce system 200 may also receive from the user 206 a consumption qualifier, such as “like,” “dislike,” “refer,” “ignore,” etc. For example, if the user 206 already knows about the product or website identified by the published notification or does not trust the user 204, the user 206 can attribute an “ignore” consumption qualifier to the submission of the identifying information associated with the user 206 to the e-commerce system 200. Consumption qualifiers may also be recorded by the e-commerce system 200 and used by the e-commerce site 210, the incentive service 212, the publication service 214, or other means to evaluate marketing trends, etc. Consumption qualifiers may also alter the way the e-commerce system 200 responds to a consuming user's submission. For example, the e-commerce system 200 may terminate publications to the user 206 based on the instructions communicated by a “stop” consumption qualifier provided by the consuming user (e.g., via navigation through a trackable URI).

The e-commerce system 200 provides benefits to all parties. The user 204 gets one or more incentives 220 in exchange for consenting to publication. The user 206 gets an incentive 222 in exchange for purchasing through the publication program of the e-commerce system 200. Moreover, the e-commerce site 210 collects commercial information from the user 204, receives promotion/advertising through publication of the commercial information, and increases sales volume when the user 206 makes a purchase.

By publishing to the search engine 216, the e-commerce system 200 can augment presentation of search results for products and services using the notifications including a user identifier of the users in the social network 202. (Examples of presentation may include displaying on a video display device, printing on a printing medium, playing an audio signal, generating and storing a signal in a storage medium such that a user may retrieve and understand the results, etc.). Accordingly, when a notified user, such as the user 206, executes a search query via the search engine 216, the search engine 216 augments its search results from a datastore of published commercial information. By finding a match between the search query/searching user and the stored keywords/user identifier found in the published notification, notifications previously published to the user 206 may be resurrected and displayed to the user 206 in the search results page.

For example, if the user 204 had published a notification to the user 206 regarding purchase of a coffee maker and to the search engine 216, the user 206 may have long forgotten about it. However, if the user 206 subsequently submits a query about “coffee makers” to the search engine 216, then the search engine 216 can search its publication datastore, find the old notification to the user 206, and present it to the user 206 with the search results. In this manner, the search results can remind the user 206 of the opportunity to ask the user 204 about the purchased product or service and offer an option to receive an incentive 222 through the publication program of the e-commerce system 200.

It should be understood that the e-commerce system 200 need not be integrated with the publication service 214 and the incentive service 212. Any one of the services 210, 212, and 214 may be operated separately from any of the other services. Indeed, it is contemplated that a single publication service and a single incentive service may support multiple e-commerce sites as third-party-provided services. Furthermore, the services 210, 212, and 214 and/or their components may be distributed over multiple computing systems.

FIG. 3 illustrates an example architecture of an e-commerce system 300 capable of capturing and publishing commercial information to a social network 302. An e-commerce site 303 includes user interface logic 304 that interacts with commercial activity of a user 304, including without limitation purchasing, researching, comparing, etc. In one implementation, the user interface logic 304 includes web server logic and/or a web application framework that defines the operation of the e-commerce site's user interface. Other user interface implementations may also be employed.

Commercial activity detection logic 308 in the e-commerce site 303 monitors the user's commercial activity, recording actions, such as purchases, product/service comparisons, specification views, etc., in a datastore 311. For example, if the user 306 purchases a product through payment logic 310 of the e-commerce site 303 (or through a third party payment service), the commercial activity detection logic 308 records the purchase into the datastore 311, including one or more of the user's ID, the product purchased, the price, the date, the method of payment, web pages view, searches performed, comparisons made, etc. (collectively referred to as “commercial information).

In association with this commercial activity, the user 306 authorizes the e-commerce system 300 to publish his or her commercial information to others in his or her social network 302. It should be understood that such authorization may occur prior to, during, or subsequent to any particular commercial activity. For example, the user 306 may establish and account with the e-commerce site 303, authorize publication at that time, and return late to shop. Alternatively, the user 306 can authorize publication at the time of purchase or during the shopping activities. In yet another implementation, the user can return to the e-commerce system 300 after completing certain commercial activity and retroactively authorize publication. In each case, the e-commerce system 300 may grant certain incentives to encourage users to provide such authorization.

In a concrete example of collecting such an authorization, the payment logic 310 displays a webpage through the user interface logic 304 offering a discount if the user 306 authorizes the e-commerce site 300 to publish the user's commercial information to his or her social network 302. The user 306, for example, may be presented with checkboxes indicating TWITTER, FACEBOOK, email, etc. By selecting one or more of the checkboxes, the user 306 is then asked to authorize social network access logic 312 of a publication service 305 to access user information from the selected social networking services of the user's social network 302. In one implementation, the user 306 is asked to provide login information to his or her TWITTER account so that the e-commerce system 300 can access identifiers of the user's followers or post tweets to the user's TWITTER account.

In one implementation, when commercial activity results in a commercial transaction (e.g., a purchase, a rental, a licensing event, a commercial commitment by both parties, etc.), the publication logic 314 accesses the social network information in the datastore 311 and publishes the commercial information regarding the commercial transaction in accordance with the user's authorization.

The publication logic 314 publishes the commercial information through the associated or designated channels. For example, if a social user was identified as a TWITTER user, then the publication logic 314 can publish the commercial information to the same user via TWITTER, although other channels may be employed based on instructions of the user 306 or the social network user. The publication logic 314 may also publish the commercial activity to a search engine 318, which can use the commercial activity to augment search results presented to notified users in the social network 302.

Incentive logic 316 of an incentive service 315 interacts with the commercial activity detection logic 308 to monitor for commercial activity by responding users. In one implementation, this monitoring can be accomplished by evaluating a trackable URI used to access the e-commerce site 303. If the URI is a trackable URI (e.g., used in a trackable notification) specifying a mapping back to the user ID of the user 306 and other information, then the incentive logic 316 may grant an incentive to the user 306 as well as the responding user. The magnitude of the incentive can depend on the size or value of the social network of user 306, on the value of the commercial activity of user 306, on the specific activities of the user 306 and the notified user (e.g., did either or both purchase the item or other items?), and other factors.

In some implementations of the e-commerce system 300, the incentive service 315 also includes payment logic 320 to monitor payment activities of the various users. Such information can be used to compute the incentive allocations to the users (e.g., based on what one or more of them actually paid for a product or service) and to display discounted prices, rebates, etc. to the users through the user interface logic 304 of the e-commerce site 303.

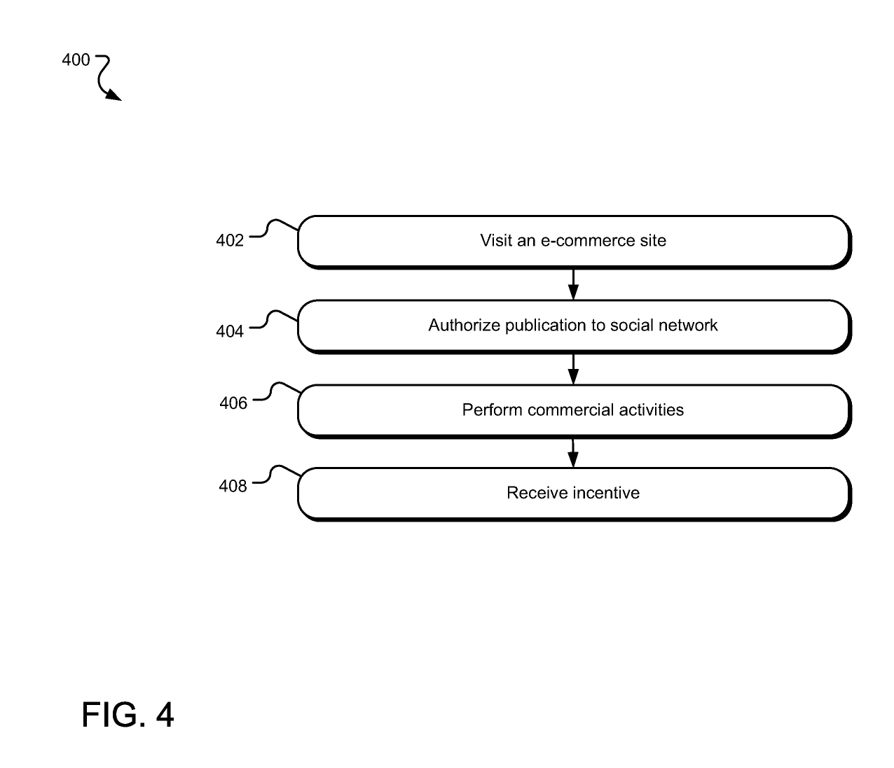

FIG. 4 illustrates example operations 400 for authorizing publication of commercial information to a social network and collecting an incentive for doing so. A navigation operation 402 enables a user to visit an e-commerce site. An authorization operation 404 provides authorizing information (e.g., a user ID, social network credentials and/or contact information) from the user. With such information, the e-commerce site can collect more social network information (e.g., tags of TWITTER followers and user names of FACEBOOK friends) and set up publication functions directed to the associated social network users.

A commercial activity operation 406 results in interaction between the user and the e-commerce site. It should be understood that operations 404 and 406 may be easily re-ordered or performed concurrently. During the commercial activity operation 406, the user navigates through the e-commerce site, reviewing product/service specifications, searching for keywords describing products/services, printing copies of web pages, downloading documents, pictures, videos, and/or software, etc. The e-commerce system logs such activity for subsequent publication of the commercial information to others in the user's social network. When the user executes a commercial transaction, the e-commerce system publishes commercial information pertaining to that transaction to the user's social network and the estimated value of their social network(s) for that specific commercial transaction. In a receiving operation 408, the initial user receives an incentive associated with this publication.

If the publication of the user's commercial information causes another user from the social network to visit the e-commerce site by virtue of a trackable notification, then the e-commerce site can provide incentive (or instructs another service, such as an ad service to provide incentive) to the user and the responding user from the social network. It should be understood that the magnitude of the incentive may be influenced by the actual commercial activity of either or both of the initial user and the responding user. In the receiving operation 408, the initial user can also receive an additional incentive corresponding to the responding user's purchase, and the responding user may also receive an incentive.

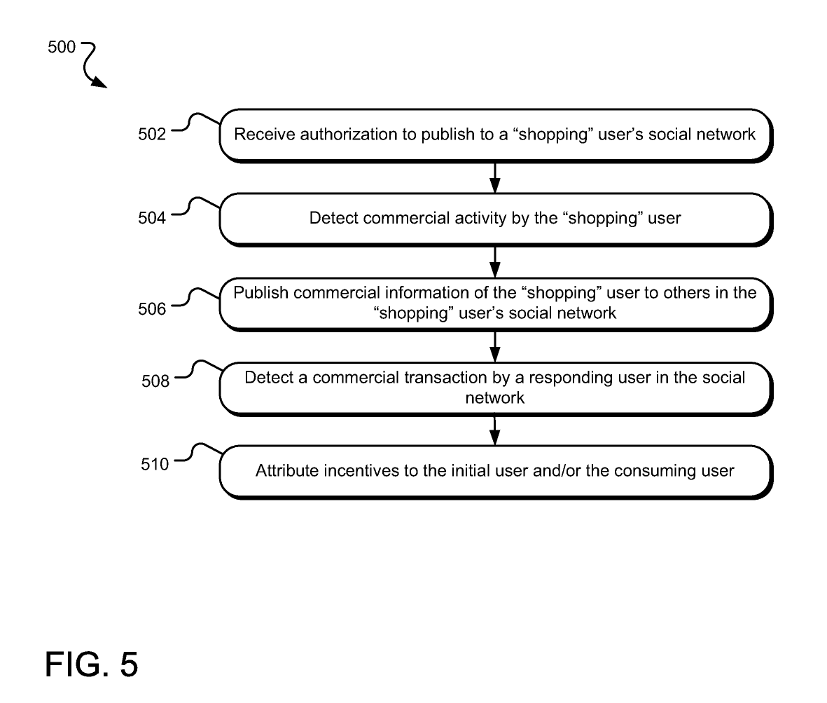

FIG. 5 illustrates example operations 500 for publishing commercial information to a social network. An authorization operation 502 causes the e-commerce site to receive authorization from a “shopping” user to publish the user's commercial information to one or more users in the shopping user's social network. For example, the shopping user may provide credential for accessing the shopping user's TWITTER account, whether to merely post tweets to the account or to access other information therein.

A detection operation 504 detects the shopping user's commercial activity within the e-commerce site and records information about the commercial activity in a datastore for later publication. Responsive to detection of a commercial transaction, a publication operation 506 publishes the commercial information of the shopping user through the authorized social networking services or using information derived therefrom.

Another detection operation 508 detects a commercial transaction by a user responding to a published notification of the shopping user's commercial transaction. For example, if the responding user accesses the e-commerce site using a trackable notification that identifies the shopping user, the detection operation 508 can detect that the responding user is responding to a published trackable notification associated with the shopping user. Accordingly, responsive to this detection, an incentive operation 510 attributes incentives to the shopping user and potentially to the responding user, based on the subsequent commercial interaction of the responding user at the e-commerce site.

It should be understood that incentives may be offered in many different forms. For example, at the time of purchase, a monetary or non-monetary discount or rebate may be provided as incentive to a shopping user to authorize access to his or her social network and publication of his or her commercial information. Alternatively, monetary or non-monetary incentives may be provided in the form of future rebates, discounts, coupons, credit at the e-commerce site, etc. Examples of non-monetary incentives may include frequent flyer miles, credit toward a free item, additional storage space in a cloud storage service, additional minutes on a wireless plan, etc. Furthermore, incentives can be multi-staged. For example, a shopping user may obtain a first incentive for authorizing publication of his or her commercial information to the social network, and a second inventive when and if a member of his or her social network purchases an item via a trackable notification.

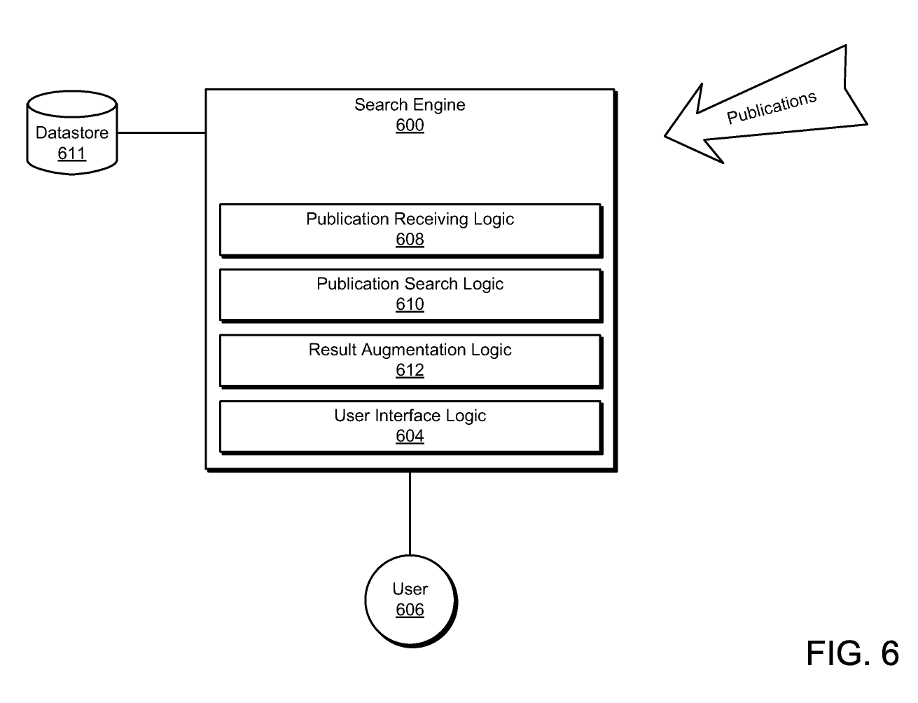

FIG. 6 illustrates an example search engine system 600 including a search feature for commercial transaction publications within a social network. The search engine system 600 is coupled to a datastore 602, which stores the received commercial transaction publications from one or more shoppers. For example, when a shopper purchases a product or service at an e-commerce system (not shown in FIG. 6), the e-commerce system publishes commercial information pertaining to that purchase to users in the shopper's social network (e.g., FACEBOOK friends) and further publishes the commercial information to the search engine system 600 for use in augmenting search results by users in the shopper's social network.

The act of publishing does not require that any particular user of the social network actually reads the publication. Instead, the transmission of the commercial information can trigger incentives and allow members of the social network to access these publications through a search engine. For example, assume commercial information about a purchase is published to members of the purchaser's social network, but none of these individuals actually read the publication. The purchaser nevertheless can enjoy the benefits of the incentive, and members of the social network can discover the publications through the search engine when they are searching for a similar product or service.

The search engine system 600 includes a user interface logic 604 that interacts with a user 606, including without limitation collecting information for a search query and displaying search results. In one implementation, the user interface logic 604 includes web server logic and/or a web application framework that defines the operation of the search engine's user interface. Other user interface implementations may also be employed.

The search engine system 600 can receive commercial transaction publications from a variety of e-commerce systems. In one implementation, the commercial information published to the search engine system 600 includes a trackable notification that identifies both the shopper and the users to whom the commercial information was published and includes information about the commercial transaction (e.g., the product or service, the price, the retailer, the manufacturer, reviews, ratings, etc.). This commercial information is received by publication receiving logic 608, which stores the received publications in the datastore 602, and typically indexes each publication to facilitate fast searching by the search engine system 600.

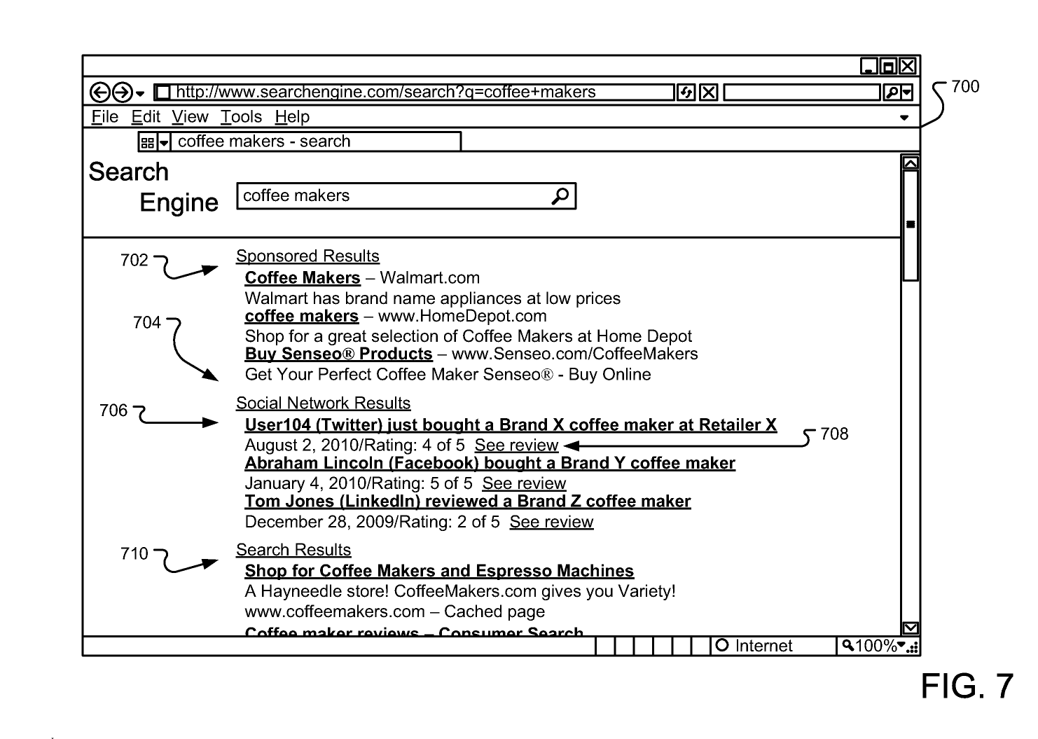

Accordingly, when a user 606, who is a member of the shopper's social network, enters a search query pertaining to a product or service that was subject to a previous publication to the user 606, publication logic 610 of the search engine system 600 searches the published commercial information in the datastore 602 for a match on the user 606 and the queried product or service. If the search engine system 600 finds one or more matches, then result augmentation logic 612 of the search engine system 600 presents the matching publications on a search results page in association with other search results (e.g., augmenting other search results such as sponsored search results and general search results typically generated by a search engine). See FIG. 7 for an example of augmented search results including search results from commercial transaction publication associated with a social network.

In some implementation, any member of the social network may be presented with publication-augmented search results if the commercial information was published to that member or to any other member of the social network. In other implementations, commercial information published to a particular member of the social network is only presented to that member. Therefore, members only see commercial information that was originally published to them.

FIG. 7 illustrates an example display 700 of augmented search results. The display 700 incorporates search results from a search query pertaining to “coffee makers.” A first set of results 702 shows sponsored results. In one implementation, entities can pay a fee to have specific links displayed more prominently than other normal search results.

A second set of results 704 shows social network publication search results, which are found by a search through commercial transaction publications associated with the searching user. In the case of FIG. 7, the searcher had previously received publications from three users in the searcher's social network pertaining to purchases of a coffee maker by each of the three users. These three search results are displayed with the original published message link 706 (e.g., a link to the original publication), an indication of which social media service that published the information, the publication date, a rating by the original purchaser (if any), and a link 708 to a review by the original purchaser (if any), although other combinations of information may be included the social network search result display. In this manner, information about coffee maker purchases in the use's social network are prominently displayed as a familiar

A third set of results 710 are shown below the social network results 704, representing the normal search results one would receive in response to a web search engine query. It should be understood that the social network search results 704 can be used to augment any combination of search results and may further be augmented themselves with other information from the associated social network services, including pictures, online status of the original purchaser, etc.

It should be understood that the social network search results may be displayed in a variety of ways to augment the search engine's search results. For example, the social network search results may be displayed in a sidebar, under a tab, in alternative combinations and orders with other search results, etc. In one implementation, the actual publication may be displayed in the search results, just as it was when it was originally published. In another implementation, a modified version of the original publication may be displayed. In yet another implementation, the augmented display includes a reference to the original publication or some modified version thereof. Furthermore, social networks search results may also be sponsored (e.g., by the brand vendor or retailer) in order to gain more prominence within the search results. In addition, the social network search results may display an offer of a discount of the searcher purchases the product or service through the links provided in the social network search results.

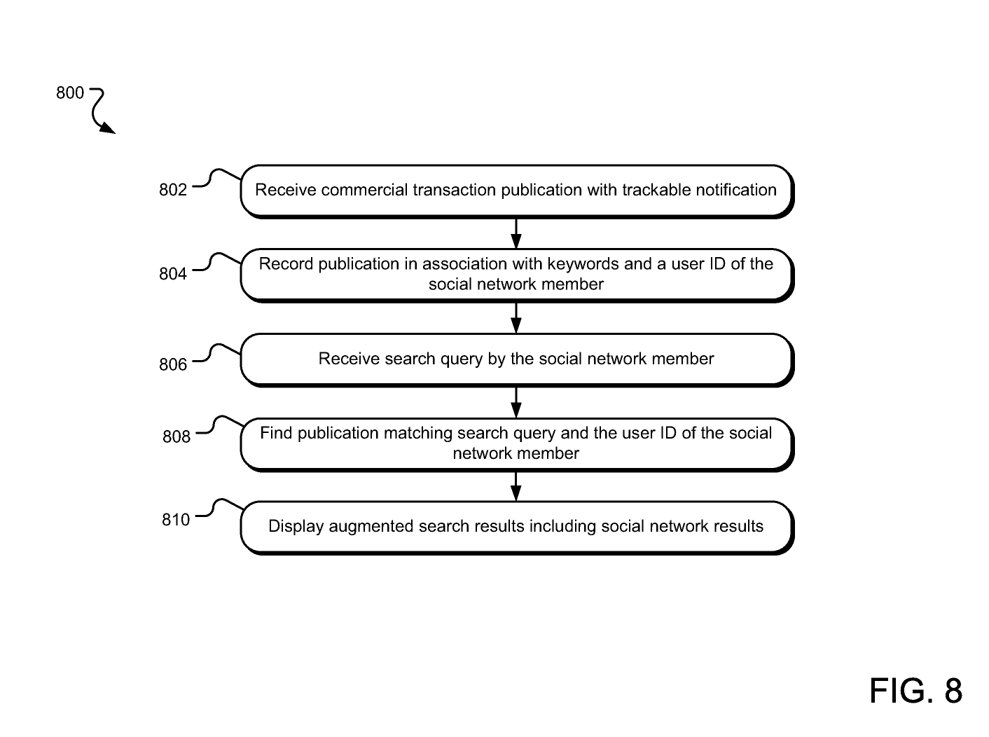

FIG. 8 illustrates example operations 800 for searching commercial transaction publications within a social network. A receiving operation 802 receives a publication of a commercial transaction by a shopper. The information about the commercial transactions has been published to members of the shopper's social network and further published to a search engine, which receives the publication in the receiving operation 802. The publication includes a trackable notification identifying one or more social network members to whom the publication was sent. A recording operation 804 records the publication, including the trackable notification, in a datastore accessible by a search engine. In one implementation, the recording operation 604 also indexes the publication based on various keywords (e.g., brand, retailer, type of product or service, etc.).

A query operation 806 receives a search query by one of the social network members. For example, the search query may specify search terms “coffee” and “maker,” along with a user ID of the social network member (which may be explicitly provided by the searcher or inferred from login data or other information). A search operation 808 searches the search engine's datastore using the search terms and the user ID. Upon detection of one or more matches to the search terms and user ID, a display operation 810 displays the social network search results in a manner that augments other search results by the search engine. The augmented display may reference or include the commercial transaction publication.

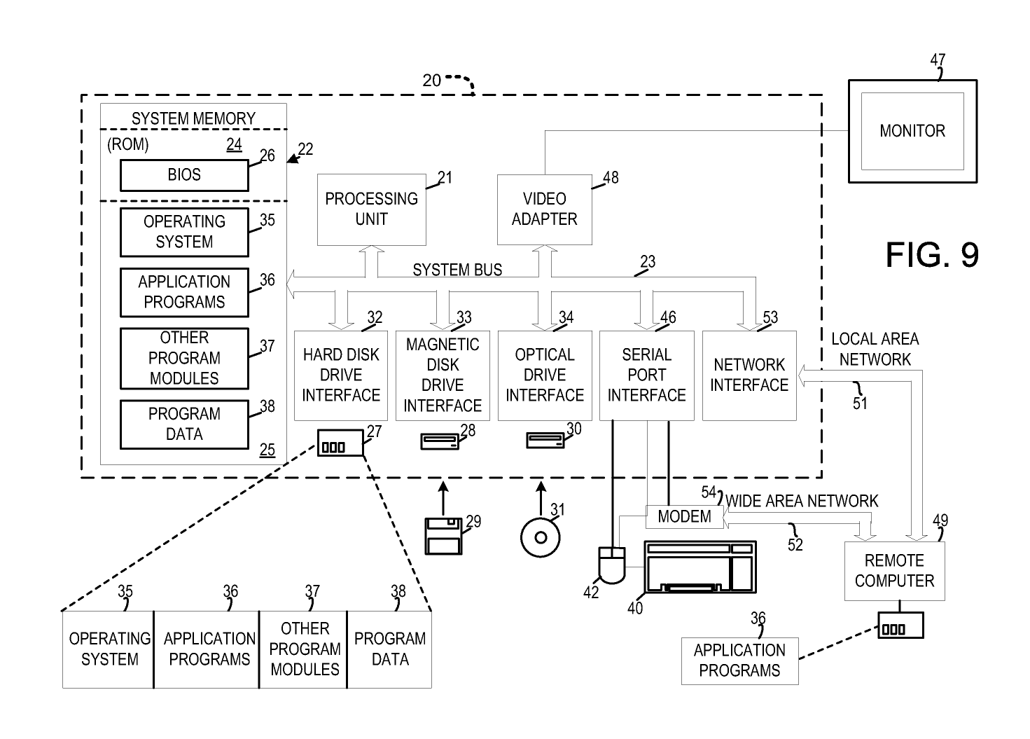

FIG. 9 illustrates an example system that may be useful in implementing the described technology. The example hardware and operating environment of FIG. 9 for implementing the described technology includes a computing device, such as general purpose computing device in the form of a gaming console or computer 20, a mobile telephone, a personal data assistant (PDA), a set top box, or other type of computing device. In the implementation of FIG. 9, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 9. The logical connections depicted in FIG. 9 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example implementation, an e-commerce system, user systems, an ad service, a search engine and other modules and services may be embodied by instructions stored in memory 22 and/or storage devices 29 or 31 and processed by the processing unit 21. User identifiers, mappings, publication and consumption qualifiers, timestamps, and other data may be stored in memory 22 and/or storage devices 29 or 31 as persistent datastores. Further, an e-commerce system, an ad service, and associated logic represent hardware and/or software configured to provide service functionality for network-connected systems. Such services may be implemented using a general purpose computer and specialized software (such as a server executing service software), a special purpose computing system and specialized software (such as a mobile device or network appliance executing service software), or other computing configurations.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. One or more computer-readable storage media encoding computer-executable instructions for executing a computing process on a computer system, the computing process comprising:
receiving a publication of a commercial transaction by a first user, the publication having been published to a member of a social network of the first user; and
augmenting, based on the publication, presentation of search results by a search engine generated responsive to a search query submitted by at least one member of the social network and relating to the commercial transaction.

2. The one or more computer-readable storage media of claim 1 wherein the augmented presentation of search results references the received publication.

3. The one or more computer-readable storage media of claim 1 wherein the augmented display of search results includes the received publication.

4. The one or more computer-readable storage media of claim 1 wherein the search engine receives a trackable notification in association with the publication, prior to initiating the search query.

5. The one or more computer-readable storage media of claim 1 wherein the commercial transaction is detected at an e-commerce site.

6. The one or more computer-readable storage media of claim 1 wherein the commercial information includes one or more publication qualifiers indicating an opinion of the first user about a product or service.

7. The one or more computer-readable storage media of claim 1 wherein the computer process further comprises:
searching a datastore storing the publication and other publications of commercial transactions for a search result publication satisfying the search query, prior to the augmenting operation.

8. The one or more computer-readable storage media of claim 1 wherein the computer process further comprises:
searching a datastore storing the publication and other publications of commercial transactions for a search result publication published to the member within the social network, prior to the augmenting operation.

9. A method comprising:
receiving a publication of a commercial transaction by a first user, the publication having been published to a member of a social network of the first user; and
presenting search results generated by a search engine responsive to a search query submitted by at least one member of the social network and relating to the commercial transaction, wherein the presented search results are based on the publication.

10. The method of claim 9 wherein the presented search results reference the received publication.

11. The method of claim 9 wherein the presented search results include the received publication.

12. The method of claim 9 wherein the search engine receives a trackable notification in association with the publication, prior to initiating the search query.

13. The method of claim 9 wherein the commercial transaction is detected at an e-commerce site.

14. The method of claim 9 wherein the commercial information includes one or more publication qualifiers indicating an opinion of the first user about a product or service.

15. The method of claim 9 wherein the computer process further comprises:
searching a datastore storing the publication and other publications of commercial transactions for a search result publication satisfying the search query, prior to the augmenting operation.

16. The method of claim 9 further comprising:
searching a datastore storing the publication and other publications of commercial transactions for a search result publication published to the member within the social network, prior to the augmenting operation.

17. The method of claim 9 further comprising:
searching a datastore storing the publication and other publications of commercial transactions for a search result publication published to the member within the social network, prior to the augmenting operation.

18. A search engine system configured to:
receive a publication of a commercial transaction by a first user, the publication having been published to a member of a social network of the first user; and
augment, based on the publication, presentation of search results generated by the search engine system responsive to a search query submitted by at least one member of the social network and relating to the commercial transaction.

19. The search engine system of claim 18 further configured to:
search a datastore storing the publication and other publications of commercial transactions for a search result publication published to the member within the social network, prior to the augmenting operation.

20. The search engine system of claim 18 further configured to:
search a datastore storing the publication and other publications of commercial transactions for a search result publication published to the member within the social network, prior to the augmenting operation.
